(19) United States
(12) Patent Application Publication
(10) Pub. No.: US 2012/0265710 A1
(43) Pub. Date: Oct. 18, 2012

(54) Method and system to evaluate and trade a liability for an uncertain tax position

(76) Inventors: George Clarke, Springfield, VA (US); Joseph Helm, Charlottesville, VA (US)

(21) Appl. No.: 13/064,813

(22) Filed: Apr. 18, 2011

(51) Int. Cl. G06Q 40/00

(52) U.S. Cl. 705/36 T

(57) ABSTRACT

Method and system to provide an exchange to enable trading of liability for uncertain tax positions between a taxpayer and a counterparty. The exchange provides risk assessments and operates as a market maker to consummate bids and acceptance thereof over a network. The method comprises obtaining over a network an indication of the valuation risk associated with the taxpayer's position; recalculating a risk profile of the tax position using weighting factors such as knowledge of tax laws, tax administrative department rulings, regulations, and court decisions; and providing the recalculated risk profile to counterparties who may place bids regarding the tax position in exchange for a proposed payment. The invention may also enable the taxpayer and counterparty to conclude a financial transaction concerning the tax position and the proposed payment. The invention is particularly directed to mitigating uncertainty regarding a taxpayer's FIN 48 tax position.

### BACKGROUND

The invention relates to a method and system for evaluating and trading a liability for an uncertain tax position, but more specifically, to an exchange or trading platform that provides valuation, bidding, and/or trading services relative to a tax position and a corresponding apparatus to implement the same.

Accounting standard Financial Accounting Standards Board Interpretation No. 48, “Accounting for Uncertainty in Income Taxes” (“FIN 48”) requires taxpayers subject to U.S. Generally Accepted Accounting Principles (“GAAP”) to maintain reserves for potential tax liabilities on uncertain tax positions. Uncertain tax positions are positions with respect to an item or transaction taxpayers take on their returns for which there is uncertainty as to ultimate resolution on tax audit, administrative appeals, or litigation. The amount of reserves set aside by a taxpayer is based on an internal assessment of the likelihood or numerical probability that the position will be ultimately sustained.

For financial reporting purposes, taxpayers with uncertain tax positions must estimate the likelihood of sustaining or prevailing on the reported treatment of the issue if the position were challenged. They are allowed to record the benefit of the reported tax treatment only if the position is “more likely than not” to be sustained and only to the extent of the likelihood of success. Thus, a taxpayer's financial statements may reflect a significant liability because of an uncertain tax position and contingent liability associated therewith. To illustrate, if the probability of a particular position is determined to be 60% likely to be sustained, the taxpayer must reserve 40% of the potential benefit. On the other hand, if the probability of a particular position is determined to be 40% likely to be sustained (and therefore not “more likely than not”), the taxpayer must reserve 100% of the potential benefit. In certain limited circumstances, the taxpayer may be able to buy FIN 48 insurance to cover the uncertain tax liability.

Traders in the industry (hereafter “counterparties”), based on their specialized knowledge and skills, may differently assess the extent of uncertainty, and for this reason, an opportunity exists to provide a mechanism to enable them to assume the risk of an unfavorable outcome on an uncertain tax position in exchange for a fee.

It also would be beneficial for a taxpayer to receive a market-driven assessment of the taxpayer's risk, thereby providing a more robust assessment of the taxpayer's uncertain tax position for financial reporting purposes.

Accordingly, this invention provides an exchange to enable taxpayers and counterparties to trade uncertain tax liabilities.

### SUMMARY

One embodiment of the invention is a method of distributing information to enable a taxpayer to trade with a counterparty an uncertain tax position. The method includes obtaining over a network an indication of the liability or asset associated with the tax position; providing a server in communication with the network to recalculate a risk profile (i.e., a level or extent of risk associated with the tax position) according to various weighting factors; sending over the network to users information about the tax position and recalculated risk profile; enabling the users to communicate bids proposing the assumption of the risk associated with the tax position in exchange for a proposed payment; and enabling the taxpayer and the counterparty to exchange the risk associated with the tax position for the proposed payment using standardized contractual terms. Other aspects of the invention provide the information about the tax position and recalculated risk profile while suppressing the identity of the taxpayer and/or of attorney-client or work product privileged information about the taxpayer.

In yet another embodiment of the invention, the method comprises receiving at least one acceptance of the bids. Another aspect involves accepting a payment to the counterparty. Different embodiments of the invention allow for the payment to be a daily payment.

The weighting factors in some embodiments of the invention may be at least one of an application of a tax code provision, jurisdiction involved, an application of a tax regulation, an application of a tax case law decision, amount of tax liability at issue, amount at issue relative to time period involved, timing relative to audit cycles and pertinent statute of limitations, FIN 48 treatment by the taxpayer, and/or an application of a tax agency ruling. Other aspects of the invention include weighting factors such as audit cycles, specialized knowledge of tax agency treatment of the tax position, risk level of the tax position assigned by the taxpayer, the credit worthiness of the taxpayer, number of audits relating to the taxpayer, the amount of the proposed payment, and the number and parameters of outstanding bids. The risk profile can be recalculated one or more times based on the weighting factors and changes in the weighting factors. The risk profile, in other embodiments of the invention, may be recalculated after one or more days.

Another aspect of the invention standardizes the bids. In different aspects of the invention the standardizing may comprise at least one of using the same bid forms, requiring the bids in a certain currency, requiring the bids to have the same payment terms, requiring the bids to have the same contingencies, requiring a floor and a ceiling amount, and requiring the same indemnifications.

In yet a further embodiment of the invention, the method comprises sending over a network an indication of said uncertain tax position; receiving from a server in communication with the network a recalculated risk profile of the tax position according to weighting factors; and receiving an indication over the network that reflects an exchange of the tax position for a proposed payment.

Some aspects of the invention contemplate an additional step of paying a value in relation to the exchange of the tax position for the proposed payment. In at least one embodiment of the invention the payment is a daily payment, and in another embodiment, the payment is assessed on the occurrence of one or more events or days.

In different embodiments, the exchange is standardized to allow side-by-side comparison. While in other embodiments, the exchange occurs in real-time.

Another aspect of the invention comprises the steps of receiving over a network a recalculated indication of a risk profile of the tax position according to weighting factors; and sending an indication over the network that reflects an exchange of the tax position for a proposed payment.

The invention contemplates in certain embodiments receiving a payment in relation to the exchange of the tax position for the proposed payment. Some aspects of the invention provide that the payment is a daily payment and other aspects assess the payment on the occurrence of one or more events or one or more days.

A preferred embodiment of the invention provides that the tax position is a FIN 48 tax position.

In yet another aspect of the invention, there is provided an apparatus for enabling a taxpayer and counterparty to exchange liability for an uncertain tax position wherein the apparatus comprises a network; at least one taxpayer workstation in communication with the network; at least one counterparty workstation in communication with the network; and an exchange server in communication with the network that (i) receives information from said taxpayer regarding the uncertain tax position, (ii) recalculates a risk profile associated with said tax position, (iii) sends the recalculated risk profile to counterparties, (iv) accepts bid proposals from said counterparties, (v) sends said bid proposals to said taxpayer, (vi) optionally enables the taxpayer to accept a bid proposal, and (vii) optionally consummates a transaction concerning a bid and acceptance thereof. In addition, the exchange server may (viii) standardize and aggregate multiple bid proposals, and (ix) send standardized and aggregated proposals to taxpayers whereby to provide a market-driven assessment of said uncertain tax position.

These and other aspects of the invention will become more apparent upon review of the following description taken in conjunction with the accompanying drawings. The invention, though, is pointed out with particularity by the appended claims.

### BRIEF DESCRIPTION OF THE DRAWINGS

FIG. 1 depicts a system diagram of an apparatus according to the present invention.

FIG. 2 is a flow chart that describes a method of distributing information to enable a taxpayer to trade with a counterparty an uncertain tax position according to one embodiment of the invention.

FIG. 3 is another flow chart that describes a method of distributing information to enable a taxpayer to trade with a counterparty an uncertain tax position according to a different embodiment of the invention.

FIG. 4 is another flow chart that describes a method of distributing information to enable a taxpayer to trade with a counterparty an uncertain tax position according to yet another aspect of the invention.

### DESCRIPTION OF ILLUSTRATIVE EMBODIMENTS

Generally, there are three classes of participants: a taxpayer, a market maker (including its computerized network and risk analysis processes), and a user (herein a “counterparty” who may purchase the taxpayer's uncertain tax position). A participant may be an entity or individual and may reside in one or more classes.

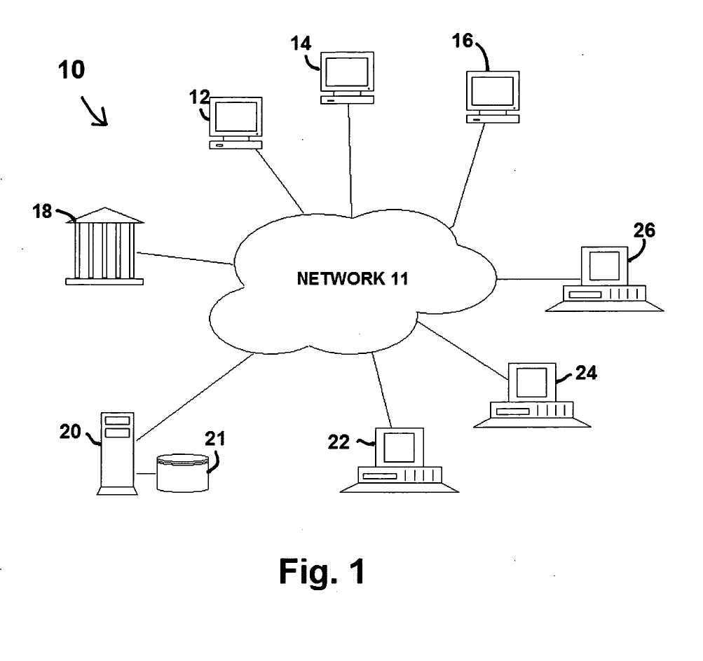

FIG. 1 exemplifies an exchange or trading system 10 that enables taxpayers and counterparties to trade tax risks. System 10 comprises a network 11 that enables information exchange over the network 11 between taxpayers and counterparties. Network 11 may convey information about tax risks between one or more taxpayers respectively situated at workstations 12, 14, and 16, on one hand, and one or more traders respectively situated at workstations 22, 24, and 26, on the other hand. An exchange server 20, which includes a database storage system 21, processes and evaluates information obtained from the taxpayers for presentation to the counterparties who, in turn, re-evaluate tax risks before submitting bids to assume the risks. Network 11 may comprise an Internet or other wide area network (WAN), a virtual private network (VPN), a local area network (LAN), or the like. The network may also comprise satellite systems, fixed and wireless mobile telephone systems, cable systems, T1 systems, ISDN lines, or multiple variations and combinations of these systems or other network systems as is commonly known in the art.

Workstations 12-16 provide computer interfaces for taxpayers that allow them to input confidential information necessary for market participants, e.g., counterparties, to assess and price risk associated with a particular tax position on a particular amount. For example, assessment of the risk may be based on jurisdiction(s) involved, code provisions/regulations at issue, timing relative to audit cycles and pertinent statutes of limitations, amount(s) at issue over what period(s), FIN 48 treatment by taxpayer, or other factors.

Exchange server 20 assigns an identification number to a swap proposal and uploads related information for presentation to market participants by sending the same over network 11 to workstations 22-26. The information may be presented in a user-friendly format and access or access levels may be restricted according to varying subscription levels of the participants.

Exchange server 20 also processes and aggregates the participants' bids on proposed swaps to display to the taxpayer(s) a market-driven view or assessment of the tax position, as well as the various amounts of bids based on standardized set of terms for trades. Processing may occur in real time to provide up-to-minute information to taxpayers. Taxpayers need not accept bids, but they may pay a fee to access server data that aggregates how market participants or the counterparties price the risk proposed for exchange.

If a bid is accepted, server 20 may initiate and conclude a financial transaction via respective accounts of the taxpayer and successful bidder through institution 18. Thus, transaction server 20 also acts as an intermediary with respect to risk buyers and also maintains confidentiality of taxpayer-specific information.

Advantageously, the invention provides market-driven underwriting that is more reliable than individual underwriting by an insurance broker and/or insurer. A market-priced risk assessment gives rise to greater clarity and certainty regarding a taxpayer's FIN 48 treatment, and would therefore more easily withstand scrutiny from financial statement auditors. In addition, the invention allows a company to monetize potential tax benefits for which there may be a significant amount of risk. Furthermore, in appropriate circumstances, a trade can be used to lay-off risk by giving away some or all of the upside on a particular tax position—in effect a “tax collar.” Also, an open market allows a counterparty investor to speculate on naked positions and to short tax positions, which may provide hedging opportunities to other market participants. These features combine to create a far more efficient means of spreading tax risk than a traditional insurance contract or similar arrangement.

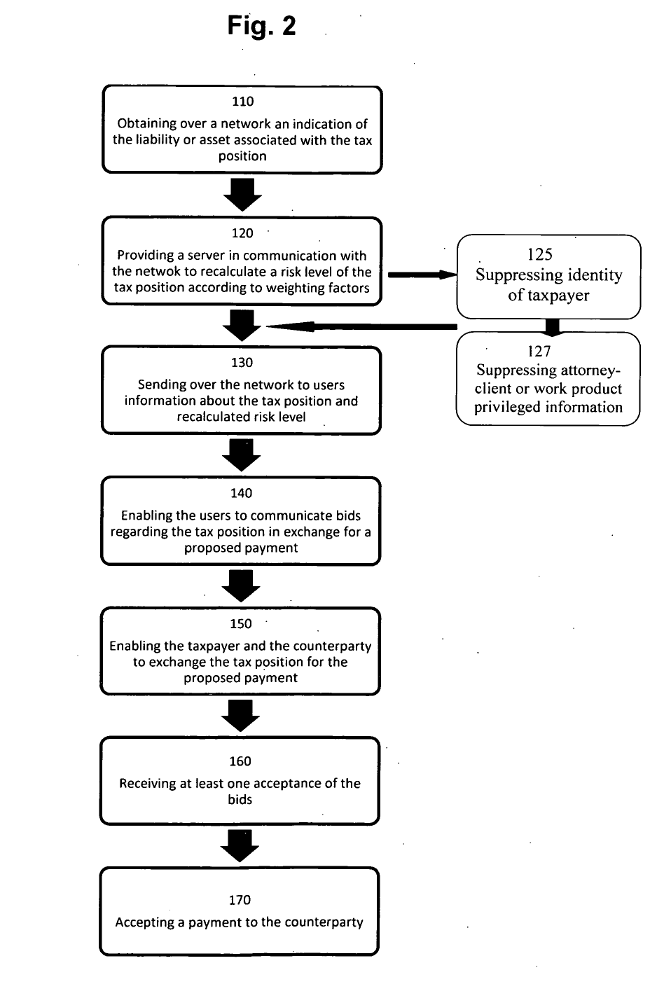

FIG. 2 illustrates another aspect of the invention directed to a method of generating and distributing assessment information to enable a taxpayer to trade with a counterparty an uncertain tax position, thereby effectively freeing the taxpayer's reserves otherwise set aside to cover the contingent tax liability. In one example, the invention is directed to a taxpayer's Financial Accounting Standards Board (FASB) 48 position (FIN 48 position), but may also apply to any taxpayer's tax position based on United States provisions or other countries' provisions for which there is an uncertain tax position.

FIG. 2 describes an aspect of the invention focusing on a market maker. In step 110, an exchange server communicating over a network obtains from a taxpayer an indication of the taxpayer's uncertain tax position. The exchange server may utilize a graphical user interface to solicit information from the taxpayer or to enable the taxpayer to input information about a tax position. In step 120 the server, based on proprietary, specialized knowledge, or other factors, recalculates a risk profile of the tax position according to various weighting factors. Risk profiles may be recalculated for a variety of reasons, such as marketability or pricing. Weighting factors may include interpretation or application of a tax code provision, a tax regulation, tax agency ruling, a tax case law decision, or amount of bids or similar uncertain tax positions proposed for exchange. Other weighting factors may comprise audit cycles, specialized knowledge of tax agency treatment of the tax position, risk level of the tax position assigned by the taxpayer, credit worthiness of the taxpayer, number of taxpayer audits, amount of proposed payment, and number of bids. In other embodiments of the invention, the market maker network server recalculates risk profiles day-by-day, or recalculates such profiles based on a change in one or more weighting factors.

In addition, a counterparty, before making a bid to buy the uncertain tax position of the taxpayer and setting a fee payment level, may apply his own risk profile analysis based on his own specialized knowledge.

In step 130, the network server sends over the network information about the tax position and recalculated risk profile to users. In optional step 125, the server suppresses the identity of the taxpayer before sending information over the network. In another step 127, the exchange server optionally suppresses attorney-client or work product privileged information about the taxpayer.

In step 140, the exchange server enables users to communicate bids to the taxpayer regarding the tax position in exchange for a proposed fee payment. In step 150, the server enables the taxpayer and counterparty to exchange the uncertain tax position for the proposed fee payment, as reflected in steps 160 and 170. The server implements these steps utilizing conventional network communications, network security safeguards, and graphical user interfaces for information exchange.

The exchange server may automatically process and communicate bids. Such bids may be standardized, which advantageously allows taxpayer, users, and counterparty to make comparisons of various pieces of information. Standardizing may comprise using standard bid forms, requiring bids in a certain currency, requiring bids to have standard payment terms, requiring bids to have the same contingencies, requiring a floor and ceiling payment amount, and/or requiring the same indemnifications.

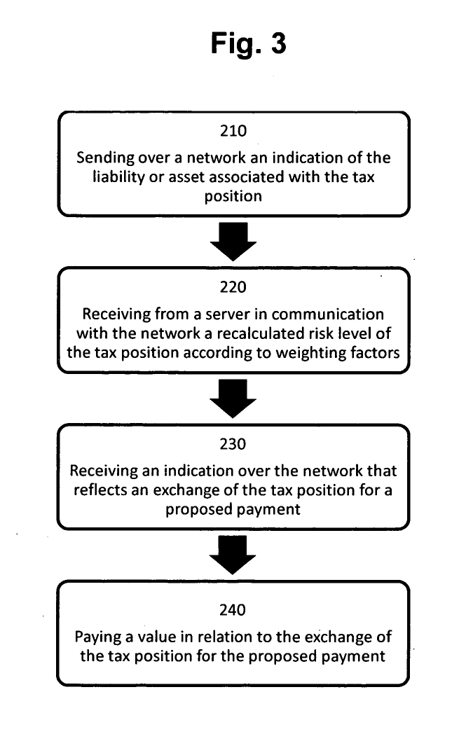

FIG. 3 describes an aspect of the invention focusing on a taxpayer. In step 210, the server or a local application residing in the taxpayer's workstation enables the taxpayer to send over a network an indication of an uncertain tax position. In step 220 a recalculated risk profile of the tax position is generated by the exchange server according to weighting factors. The server then sends over the network the recalculated risk profile to counterparties requesting this information. The weighting factors may comprise a number of factors, as previously explained.

In step 230, the taxpayer receives from one or more counterparties bid information indicative of a proposed exchange of the tax position and proposed payment terms. Bid information may be received in real-time, or on an ad hoc basis when requested or accessed by the taxpayer. In another aspect of the method, the exchange server standardizes multiple bids and presents the same to the taxpayer to enable a side-by-side comparison of the multiple bids whereupon the taxpayer may choose which bid to accept.

In step 240, the exchange server completes the trade over the network by consummating the bid offer and the taxpayer's acceptance. Conventional security measures may be implemented during the trade to assure confidentiality of the transaction between the taxpayer and successful counterparty. The server may also execute a payment through financial institutions according to the bid and acceptance terms and thereafter send respective notices to the taxpayer and counterparty using secure on-line transaction methods, as known in the art.

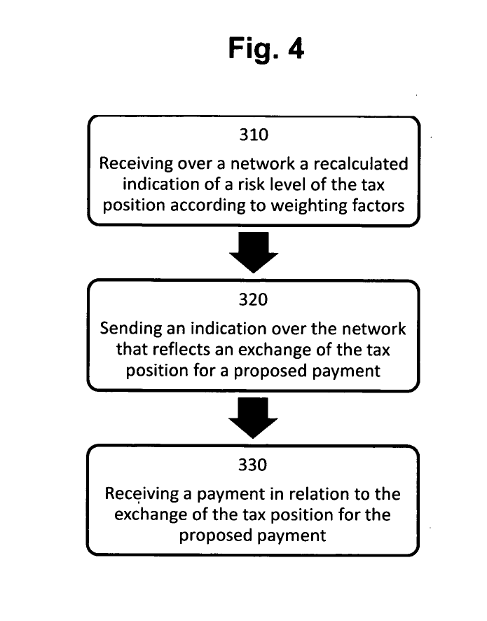

FIG. 4 illustrates an aspect of the method focusing on the counterparty. In step 310, the counterparty receives over a network a server-generated, recalculated indication of a risk profile of the taxpayer's uncertain tax position according to weighting factors.

In step 320 the server sends over the network information that proposes an exchange of the tax position for a proposed payment. This information may be received in real-time or on an ad hoc basis upon request of the counterparty. Prior to sending the information over the network, the server may standardize multiple tax positions of one or more taxpayers to enable the counterparty to make a side-by-side comparison of multiple tax positions.

In step 330, after the counterparty confirms an acceptance, the server completes the transaction by conventional means, as explained above.

The foregoing descriptions of specific embodiments of the present invention are presented for illustrative purposes. They are not intended to be exhaustive or to limit the invention to the precise forms disclosed. To one of skill in the art, many modifications and variations will be evident in light of the above teachings.

1. A method of enabling a taxpayer and a counterparty to trade over a network an uncertain tax position comprising the steps of:
a. Enabling said taxpayer to send over said network information characterizing said uncertain tax position;
b. Providing an exchange server to receive said information to recalculate a risk profile associated with said uncertain tax position according to weighting factors;
c. Sending over said network to said counterparty information about said tax position and said recalculated risk profile;
d. Enabling said counterparty to generate and send a bid to said taxpayer to assume liability for said uncertain tax position in exchange for a payment; and
e. Consummating exchange of liability for said uncertain tax position between the taxpayer and counterparty over the network according to said bid and acceptance thereof.

2. The method according to claim 1 further comprising providing said information about said tax position and recalculated risk profile while suppressing the identity of said taxpayer.

3. The method according to claim 1 wherein said method further comprises providing said information about said tax position and recalculated risk profile while suppressing attorney-client or work product privileged information about said taxpayer.

4. The method according to claim 1 further comprising the step of receiving at least one acceptance of said bids.

5. The method according to claim 1 further comprising the step of accepting a payment to said counterparty.

6. The method according to claim 1 wherein said payment is a daily payment.

7. The method according to claim 1 wherein said weighting factors comprise at least one of an application of a tax code provision, jurisdiction, an application of a tax regulation, an application of a tax case law decision, amount of said bids, and an application of a tax agency ruling.

8. The method according to claim 7 wherein said weighting factors further comprise audit cycles, specialized knowledge of tax agency treatment of said tax position, risk level of said tax position assigned by taxpayer, credit worthiness of taxpayer, number of taxpayer audits, amount of proposed payment, and number of bids.

9. The method according to claim 1 further comprising further recalculating said risk profile based on a change in said weighting factors.

10. The method according to claim 1 further comprising recalculating said risk profile after one or more days.

11. The method according to claim 1 further comprising standardizing said bids.

12. The method according to claim 11 wherein said standardizing comprises at least one of using same bid forms, requiring said bids in certain currency, requiring said bids to have same payment terms, requiring said bids to have same contingencies, requiring a floor and ceiling payment amount, requiring same indemnifications.

13. The method according to claim 1 wherein said tax position is a FIN 48 tax position.

14. A method of distributing information to enable a taxpayer to trade with a counterparty a liability for an uncertain tax position, said method comprising the steps of:
a. sending over a network an indication of said uncertain tax position;
b. receiving from a server in communication with said network a recalculated risk profile of said tax position according to weighting factors; and
c. receiving an indication over said network that reflects an exchange of said liability for an uncertain tax position for a proposed payment.

15. The method according to claim 14 further comprising the step of paying a value in relation to said exchange of said tax position for said proposed payment.

16. The method according to claim 15 wherein said payment is a daily payment.

17. The method according to claim 15 wherein said payment is assessed on the occurrence of one or more events.

18. The method according to claim 15 wherein said payment is reassessed after one or more days.

19. The method according to claim 14 wherein said indication that reflects said exchange is standardized to allow side-by-side comparison.

20. The method according to claim 14 wherein said indication that reflects said exchange is received in real-time.

21. The method according to claim 14 wherein said tax position is a FIN 48 tax position.

22. A method of distributing information to enable a taxpayer to trade with a counterparty a liability for an uncertain tax position, said method comprising the steps of:
a. Receiving over a network a recalculated indication of a risk profile of said tax position according to weighting factors; and
b. Sending an indication over said network that reflects an exchange of said tax position for a proposed payment.

23. The method according to claim 22 further comprising the step of receiving a payment in relation to said exchange of said tax position for said proposed payment.

24. The method according to claim 23 wherein said payment is a daily payment.

25. The method according to claim 23 wherein said payment is assessed on the occurrence of one or more events.

26. The method according to claim 23 wherein said payment is reassessed after one or more days.

27. The method according to claim 22 wherein said indication that reflects said exchange is standardized to allow side-by-side comparison.

28. The method according to claim 22 wherein said indication that reflects said exchange occurs in real-time.

29. The method according to claim 22 wherein said tax position is a FIN 48 tax position.

30. Apparatus for enabling a taxpayer and counterparty to exchange liability for an uncertain tax position, said apparatus comprising:
a. a network,
b. at least one taxpayer workstation in communication with said network, and
c. at least one counterparty workstation in communication with said network,
an exchange server in communication with said network including one that (i) receives information from said taxpayer regarding the uncertain tax position, (ii) recalculates a risk profile associated with said tax position, (iii) sends the recalculated risk profile to counterparties, (iv) accepts bid proposals from said counterparties, (v) sends said bid proposals to said taxpayer, (vi) optionally enables the taxpayer to accept a bid proposal, and (vii) optionally consummates a transaction concerning a bid and acceptance thereof.

31. The invention of claim 30 wherein said exchange server (viii) standardizes and aggregates multiple bid proposals, and (ix) sends said standardized and aggregated proposals to said taxpayer whereby to provide a market-driven assessment of said uncertain tax position.
